(19) United States
(12) Patent Application Publication
(10) Pub. No.: US 2003/0234501 A1
(43) Pub. Date: Dec. 25, 2003

(54) Wheeled base

(76) Inventor: Ohad Mordehai Cohen, Reut (IL)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/465,635

(22) Filed: Jun. 20, 2003

(30) Foreign Application Priority Data
Jun. 25, 2002 (IL) 150,391

(51) Int. Cl. B62B 1/00

(52) U.S. Cl. 280/47.24

(57) ABSTRACT

The invention provides a wheeled base for luggage, a golf club bag, dollies and the like, the base comprising an axle having a pair of spaced-apart primary transport wheels provided at opposite ends thereof and further comprising a pair of spaced-apart secondary transport wheels, wherein each of the secondary transport wheels is provided with an axle which can be extended telescopically from ends of the axle supporting the pair of primary transport wheels, the arrangement being such that each of the secondary wheels is displaceable between a first compact position adjacent to an outer side of one of the primary wheels and co-axial therewith, and a second position extended in a spaced-apart array relative to its initially-adjacent primary wheel to form a base with four mutually spaced-apart co-axial transport wheels.

The present invention relates to a wheeled-base for luggage, a golf club bag, dollies, and the like and especially to the transport of luggage.

More particularly, the invention provides a wheeled-base integrally formed with an article of luggage, a golf bag or the like, as well as to trolleys for luggage and dollies for transport of heavy articles incorporating the wheeled-base according to the present invention which wheeled-base is stable in use and compact in storage.

Persons traveling take along clothing and other personal items, which can be carried in a suitcase or rucksack. Children, the elderly and others with less than full strength often prefer to use a trolley or suitcase provided with wheels. People shopping also find a trolley eases the task of bringing home the goods purchased, and some golfers use a trolley to transport a bag carrying their clubs. Thus the bulk of the load from the lifting muscles of the user is transferred to the ground. Depending on the smoothness of the surface being traversed, and on the wheel diameter, the pulling force needed is typically in the range 0.1-0.3 of the weight being carried, thus making it possible for those of more limited physical strength to transfer luggage or other loads which could not otherwise be carried.

Luggage-carrying trolleys have been in use for many decades, and are well known in the art, examples being seen in U.S. Pat. No. 5,127,664 to Cheng, U.S. Pat. No. 5,308,103 to Chin-Shung, U.S. Pat. No. 5,639,109 to Liang, and U.S. Pat. No. 5,678,843 to Liu. The known trolleys all have a fixed wheelbase, the innovations mainly concern the details of the telescopic pull handle.

Wheeled trolleys and wheeled suitcases are put in storage when not in use. In order to take up as little storage space as possible, many trolleys are of foldable or collapsible construction. The distance between wheels is however usually fixed.

A major problem with luggage trolleys and even more with wheeled suitcases is a lack of sideways stability when loaded and being pulled over rough pavements and over or down steps. The distance spanned by the wheels of a typical wheeled suitcase is about 30 cm, according to the thickness of the luggage item supported by said wheels. When in use such a suitcase swings from side to side if the pavement is not smooth, and similarly if pulled up or down a step at any angle except the perpendicular. Often the wheels lose all contact with the ground and the user must stop to replace the suitcase in its upright position.

Clearly, there is a conflict between storability and a wide stable wheelspan. If a trolley or suitcase is fitted with widely spaced-apart wheels, storage thereof becomes difficult. If the wheelspan is limited so as not to project beyond the suitcase or trolley structure, the wheeled structure becomes unstable on any but flat, smooth surfaces. Such surfaces are rarely found outdoors.

A further limitation of prior-art trolleys is that when pulled along an unpaved surface, resistance rises sharply due to the wheels partially sinking into the ground.

It is therefore one of the objects of the present invention to obviate the disadvantages of prior art wheeled luggage items and trolleys and to provide a wheeled trolley and a luggage item such as a suitcase which is easier to draw along due to improved side-to-side stability.

It is a further object of the present invention to reduce rolling resistance of the luggage when pulled over soft or stony ground.

Yet a further object of the present invention is to provide a luggage trolley which is foldable when not in use into a very small volume.

The present invention achieves the above objects by providing a wheeled-base for luggage, a golf club bag, dollies and the like, said base comprising an axle having a pair of spaced-apart primary transport wheels provided at opposite ends thereof and further comprising a pair of spaced-apart secondary transport wheels, wherein each of said secondary transport wheels is provided with an axle which can be extended telescopically from ends of said axle supporting said pair of primary transport wheels, the arrangement being such that each of said secondary wheels is displaceable between a first compact position adjacent to an outer side of one of said primary wheels and co-axial therewith, and a second position extended in a spaced-apart array relative to its initially-adjacent primary wheel to form a base with four mutually spaced-apart co-axial transport wheels.

In a preferred embodiment of the present invention there is provided an integrally-formed article of luggage and wheeled base thereof.

In a most preferred embodiment of the present invention there is provided a trolley for supporting luggage, of the type having a base with an axle having a pair of spaced-apart primary transport wheels provided at opposite ends thereof, an extendible pull handle and a deployable and collapsible luggage support member, further comprising a pair of spaced-apart secondary transport wheels, wherein each of said secondary transport wheels is provided with an axle which can be extended telescopically from ends of said axle supporting said pair of primary transport wheels, the arrangement being such that each of said secondary wheels is displaceable between a first compact position adjacent to an outer side of one of one of said primary wheels and co-axial therewith, and a second position extended in a spaced-apart array relative to its initially-adjacent primary wheel to form a base with four mutually spaced-apart co-axial transport wheels.

Yet further embodiments of the invention will be described hereinafter.

It will thus be realized that the novel wheeled-base of the present invention serves to provide more stable movement over uneven or soft ground surfaces, for example moving a bag of golf clubs over grass. The wheel pressure on the ground is reduced by the extra wheels, which reduces the required pull effort is also important also for preventing damage to the grass. Yet the wheeled-base is telescopically collapsible so as to be easily taken in a vehicle and to be readily stored practically anywhere.

A compact folded volume is also important for marketing purposes. Many retailers are reluctant to buy and stock any bulky item in a quantity supporting significant sales. The small folded volume of the products incorporating the wheeled-base of the present invention can thus be used as a sales tool.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### IN THE DRAWINGS

FIG. 1 is a perspective view of a preferred embodiment of the wheeled luggage base according to the invention, shown with extended wheels;

FIG. 2 is a photographic view of a golf club container, shown with the wheels in retracted form;

FIG. 3 is an elevational view of an embodiment provided with a detent preventing inadvertent excessive extension of the secondary transport wheels;

FIG. 4 is an elevational view of an embodiment provided with a spring clip detent;

FIG. 5 is a perspective view of a luggage trolley according to the invention, shown with the secondary road wheels retracted; and

FIG. 6 is a perspective view of the same embodiment shown with the secondary road wheels in their extended configuration.

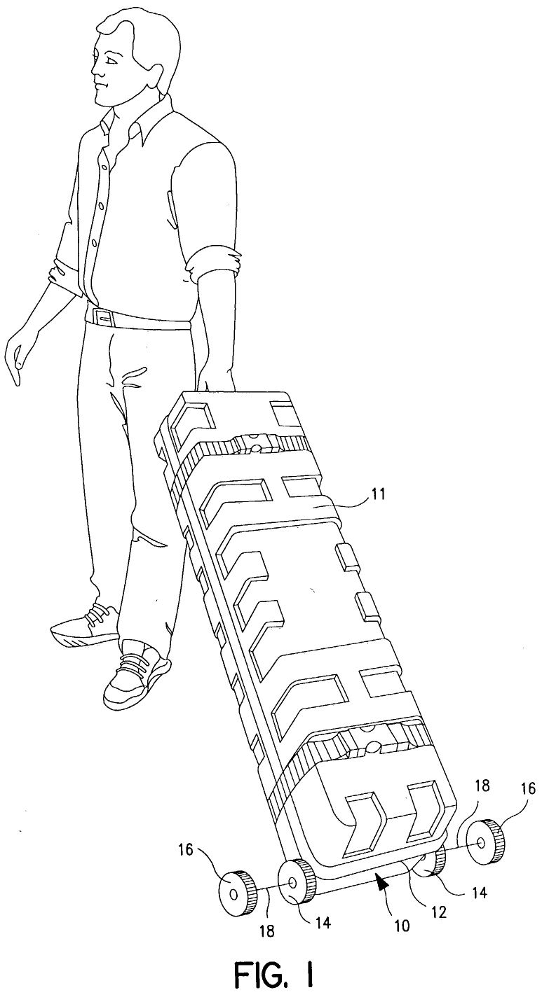

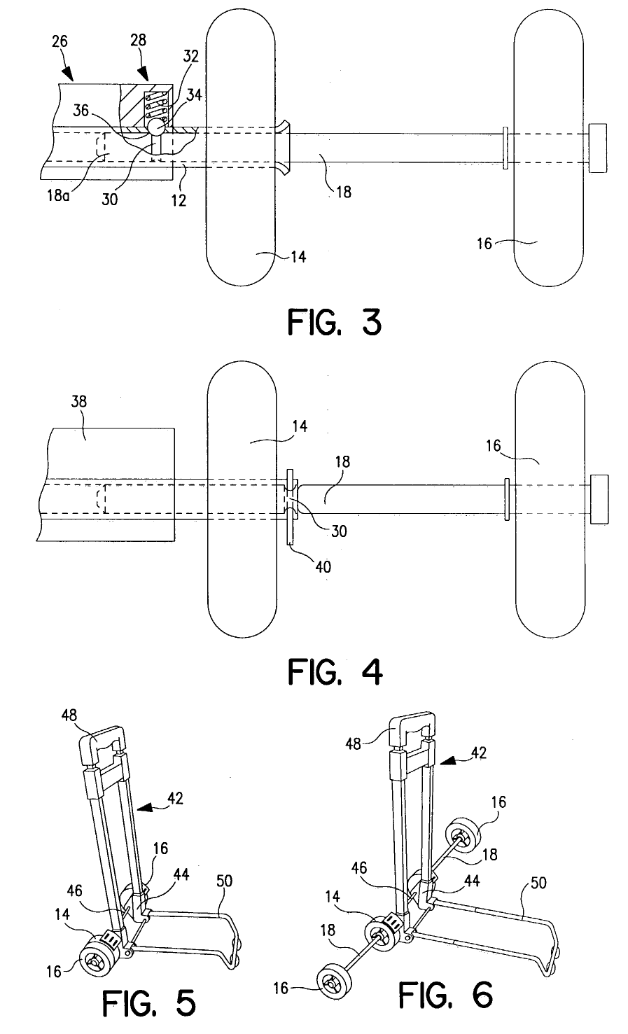

There is seen in FIG. 1 a wheeled base 10 for luggage 11. The base 10 comprises an at least partially hollow axle 12 having a pair of spaced-apart primary transport wheels 14 revolvably attached at opposite ends thereof. Indirectly supported by the axle 12 are a pair of spaced-apart secondary transport wheels 16. Each of the wheels 16 is revolvably attached at an extremity of an axle 18 that can be extended telescopically from ends of the axle 12 supporting the pair of primary transport wheels 14. The arrangement will be seen in more detail in FIG. 3.

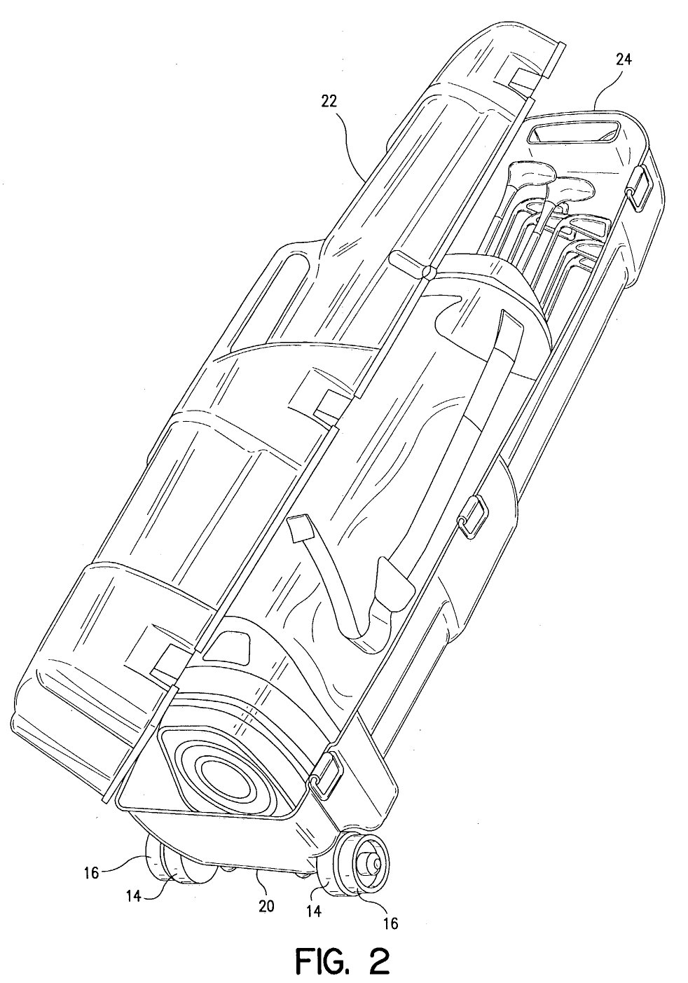

The secondary wheels 16, together with axle 18, are thus displaceable between a first compact position, seen in FIG. 2, adjacent to an outer side of one of the primary wheels 14 and co-axial therewith, and a second position extended in a spaced-apart array relative to its initially-adjacent primary wheel 14. When extended, a base 10 is formed with four mutually spaced-apart co-axial transport wheels 14, 16.

With regard to the rest of the figures, similar reference numerals have been used to identify similar parts.

Referring now to FIG. 2, there is seen a wheeled base 20 integrally formed with a carrier case 22 for a golf club bag, however, said wheeled-base could also be integrally formed with the golf club bag itself. A handle 24 is molded in as part of the casing and is used for pulling the luggage article 22.

FIG. 3 illustrates a detail of a wheeled base 26 wherein detent devices 28 are provided to contact the hollow axle 12 supporting a primary transport wheel 14 at each end. The detent 28 also contacts the telescopically extendible axles 18 of the secondary wheels 16. The detent is disposed to engage a peripheral groove 30 in the extendible axle 18 when in the extended position. A substantial length 18a of the telescopically extendible axle 18 remains in support contact with the hollow axle 12 supporting the primary transport wheels 14.

In the present embodiment the detent comprises a spring 32 and ball 34 which are housed in a fixed part of the base 26. The ball 34 projects through an aperture 36 which is smaller than the ball diameter, and the ball 34 engages a groove 30 in the extendible axle 18.

The detent 28 is most helpful in preventing unintended separation of the axles 12,18 when pulled outwards for use.

Seen in FIG. 4 is a detail of a wheeled base 38 wherein the detent devices comprise a groove 30 formed in each of the telescopically extendible axles 18 of the secondary wheels 16, in combination with a strong spring clip 40 retained proximate to each end of the hollow axle 12.

The spring clip 40 serves the further purpose of limiting outwards movement of the secondary transport wheels 16.

Referring now to FIGS. 5 and 6, there is depicted a trolley 42 for supporting and manually transporting luggage. The trolley is a versatile vehicle which can be used for transporting a wide variety of loads within its rated weight limit.

The trolley has a base 44 with a hollow axle 46 having a pair of spaced-apart primary transport wheels 14 provided at opposite ends thereof.

Also provided are an extendible pull handle 48 and a deployable and collapsible luggage support member 50, and a pair of spaced-apart secondary transport wheels 16. Each of the secondary transport wheels 16 is provided with an axle 18 that can be extended telescopically from ends of the hollow axle 46 supporting the pair of primary transport wheels 14.

The arrangement is such that each of the secondary wheels 16 is displaceable between a first compact position adjacent to an outer side of one of one of the primary wheels 14 and co-axial therewith, as seen in FIG. 5. In a second position the secondary wheels 16 are extended in a spaced-apart array relative to its initially-adjacent primary wheel 14 to form a base with four mutually spaced-apart co-axial transport wheels as seen in FIG. 6.

As will be realized an additional advantage of the trolley of the present invention is that its extendable wheeled-base facilitates the use of said trolley with pieces of luggage of varying dimensions. As will also be realized said wheeled-base can be incorporated in a dolly in a similar manner to that described above for the luggage trolley.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A wheeled base for luggage, a golf club bag, dollies and the like, said base comprising an axle having a pair of spaced-apart primary transport wheels provided at opposite ends thereof and further comprising a pair of spaced-apart secondary transport wheels, wherein each of said secondary transport wheels is provided with an axle which can be extended telescopically from ends of said axle supporting said pair of primary transport wheels, the arrangement being such that each of said secondary wheels is displaceable between a first compact position adjacent to an outer side of one of said primary wheels and co-axial therewith, and a second position extended in a spaced-apart array relative to its initially-adjacent primary wheel to form a base with four mutually spaced-apart co-axial transport wheels.

2. A wheeled base according to claim 1, whenever integrally formed with an article of luggage and constituting the wheeled base thereof.

3. A wheeled base according to claim 1, whenever integrally formed with a golf club bag and constituting the wheeled base thereof.

4. A wheeled base according to claim 1, wherein detent devices are provided to contact said axle supporting said pair of spaced-apart primary transport wheels and said telescopically extendible axles of said secondary wheels, said detents being positioned to engage said axles of said secondary wheels in said extended position wherein a substantial length of said telescopically extendible axles remains in support contact with said axle supporting said primary transport wheels.

5. A wheeled base according to claim 4, wherein said detent devices comprise a groove formed in each of said telescopically extendible axles of said secondary wheels, in combination with a spring clip retained proximate to each end of said axle supporting said primary transport wheels.

6. A trolley for supporting luggage having a wheeled-base according to claim 1, of the type having a base with an axle having a pair of spaced-apart primary transport wheels provided at opposite ends thereof, an extendible pull handle and a deployable and collapsible luggage support member, further comprising a pair of spaced-apart secondary transport wheels, wherein each of said secondary transport wheels is provided with an axle which can be extended telescopically from ends of said axle supporting said pair of primary transport wheels, the arrangement being such that each of said secondary wheels is displaceable between a first compact position adjacent to an outer side of one of one of said primary wheels and co-axial therewith, and a second position extended in a spaced-apart array relative to its initially-adjacent primary wheel to form a base with four mutually spaced-apart co-axial transport wheels.
